(19) United States
(12) Patent Application Publication
(10) Pub. No.: US 2026/0244085 A1
(43) Pub. Date: Aug. 20, 2026

(54) PROJECTOR COVER MEMBER

(71) Applicant: SEIKO EPSON CORPORATION, Tokyo (JP)

(72) Inventors: Ippei KUROTA, MATSUMOTO-SHI (JP); Yuki KOBAYASHI, SUZAKA-SHI (JP); Akira MOMOSE, SHIOJIRI-SHI (JP)

(21) Appl. No.: 19/538,490

(22) Filed: Feb. 12, 2026

(30) Foreign Application Priority Data
Feb. 14, 2025 (JP) 2025-022501

(51) Int. Cl. G03B 21/14; G03B 21/16; G10K 11/16

(52) U.S. Cl. CPC G03B 21/145; G03B 21/16; G10K 11/16

(57) ABSTRACT

The projector cover member 1 covers a projector including an outer housing 20, a power supply section 32 arranged in the outer housing 20, and an image light generation module controlled by the power supply section 32, and at least an outer surface is formed of wood, and includes a power supply hole section 41 that overlaps with the power supply section 32 in plan view. The power supply hole section 41 includes an opening larger than a peripheral edge of the power supply section 32.

The present application is based on, and claims priority from JP Application Serial Number 2025-022501, filed February 14, 2025, the disclosure of which is hereby incorporated by reference herein in its entirety.

### BACKGROUND

### 1. Technical Field

The present disclosure relates to a projector cover member.

### 2. Related Art

In the related art, there is known a projector including a projector main body and a carrying case that stores the projector main body (see, for example, JP-A-2000-180962). In this case, the projector includes a light transmission port, a ventilation section, and the like so that the projector can project light while being stored in the carrying case. As illustrated in Japanese Patent No. 3935798, there is an electronic device such as a projector whose housing is made of only wood or a wood-based material.

However, the structure disclosed in JP-A-2000-180962 is inferior in the appearance because the carrying case itself is used as the external appearance, and is weak against external impact. In a state in which the projector main body is stored in the carrying case, there is a problem that it is difficult to operate a power switch or the like provided in the projector main body, and the usability is poor.

In a case where the housing itself of the electronic device is made of only wood or the wood-based material as in Japanese Patent No. 3935798, the appearance is better than that of JP-A-2000-180962, but it is difficult to attach a part to the housing, and the function as an electronic part such as a projector is limited, and thus there is room for improvement in this respect.

### SUMMARY

According to one aspect of the present disclosure, a projector cover member configured to cover a projector, the projector including an outer housing, a power supply section arranged in the outer housing, and an image light generation module controlled by the power supply section, wherein at least an outer surface of the projector cover member is formed of wood, the projector cover member includes a first hole section that overlaps with the power supply section in plan view, and the first hole section includes an opening larger than a peripheral edge of the power supply section is provided.

### BRIEF DESCRIPTION OF THE DRAWINGS

FIG. 1 is a perspective view illustrating a configuration of a cover member that accommodates a projector according to an embodiment of the present disclosure, as viewed obliquely from front.

FIG. 2 is an exploded perspective view of a state before the projector is stored in the cover member, as viewed obliquely from rear.

FIG. 3 is a perspective view illustrating a configuration of the projector as viewed obliquely from the front.

FIG. 4 is a front view of the cover member as viewed from the front.

FIG. 5 is a rear view of the cover member as viewed from the rear.

FIG. 6 is a side view of the cover member that accommodates the projector, as viewed from a right side.

FIG. 7 is a side view of the cover member that accommodates the projector, as viewed from a left side.

FIG. 8 is a plan view of the cover member that accommodates the projector, as viewed from below.

FIG. 9 is a horizontal cross-sectional view of a speaker hole section as viewed from a vertical direction.

FIG. 10 is a cross-sectional view of an intake port hole section and an exhaust port hole section as viewed from a front- rear direction.

### DESCRIPTION OF EMBODIMENTS

Hereinafter, an embodiment of the present disclosure will be described with reference to the drawings.

In the following drawings, the scale of dimensions may be changed depending on components in order to make the components easy to see.

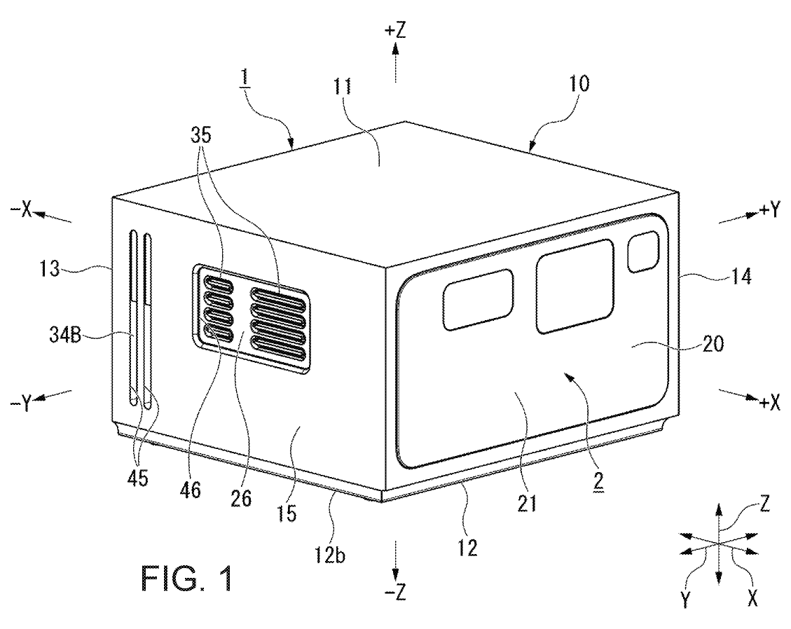

As illustrated in FIG. 1, a projector cover member (hereinafter simply referred to as a "cover member 1") according to the embodiment covers a projector 2.

A Z-axis direction appropriately illustrated in each drawing is a vertical direction in which a +Z direction is an upper side and a -Z direction is a lower side. An X-axis direction and a Y-axis direction are horizontal directions orthogonal to the Z-axis direction and are directions orthogonal to each other. In the following description, a direction parallel to the Z-axis direction is referred to as a vertical direction Z, a direction parallel to the X-axis direction is referred to as a front-rear direction X, and a direction parallel to the Y-axis direction is referred to as a left-right direction Y. A +Y direction of the Y-axis direction is referred to as a right side, and a -Y direction of the Y-axis direction is referred to as a right left side. A +X direction of the X-axis direction is referred to as a front side, and a -X direction of the X-axis direction is referred to as a rear side.

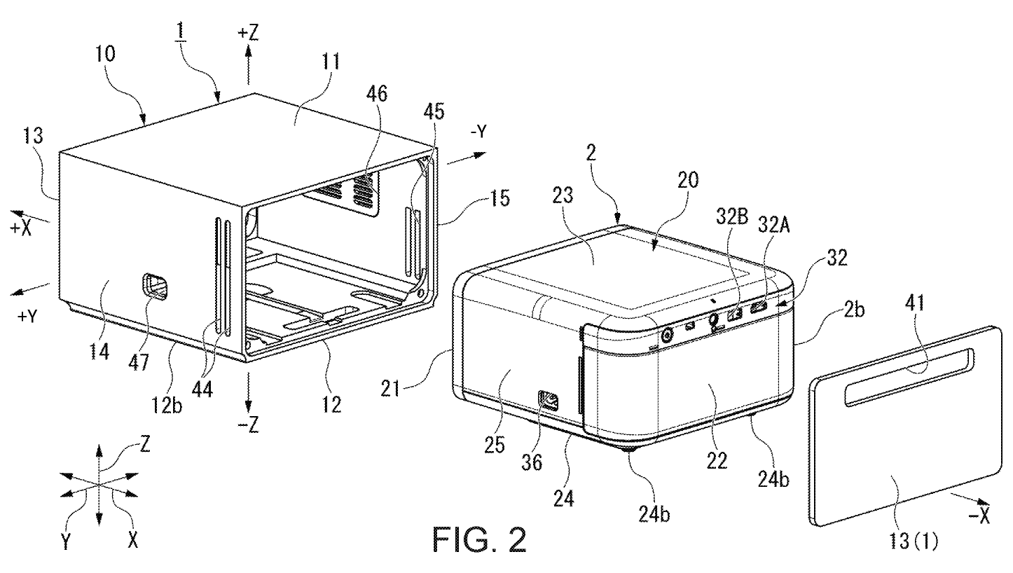

FIG. 1 is a perspective view illustrating a configuration of the cover member 1 that accommodates the projector 2 according to the present embodiment, as viewed obliquely from front. FIG. 2 is an exploded perspective view of a state before the projector 2 according to the present embodiment is stored in the cover member 1, as viewed obliquely from rear. As illustrated in FIGS. 1 and 2, the projector 2 according to the present embodiment projects an image on a screen (not illustrated). The projector 2 is a stationary projector installed on an installation surface G and used, and is a short-throw projector. The installation surface G is a surface facing upward. The installation surface G is, for example, a flat surface orthogonal to the vertical direction Z. The projector 2 includes an outer housing 20 and an image light generation module (not illustrated) controlled by a power supply section 32 arranged in the outer housing 20. The image light generation module includes a light source, a light guide system, and a projection optical device.

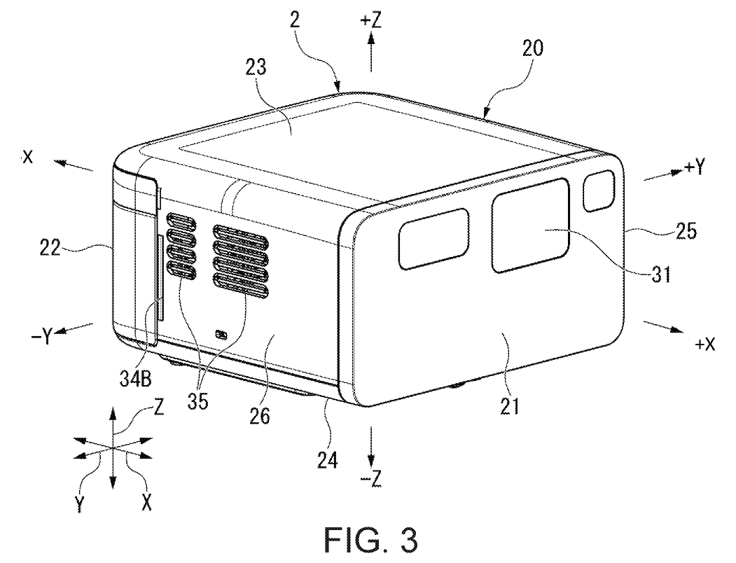

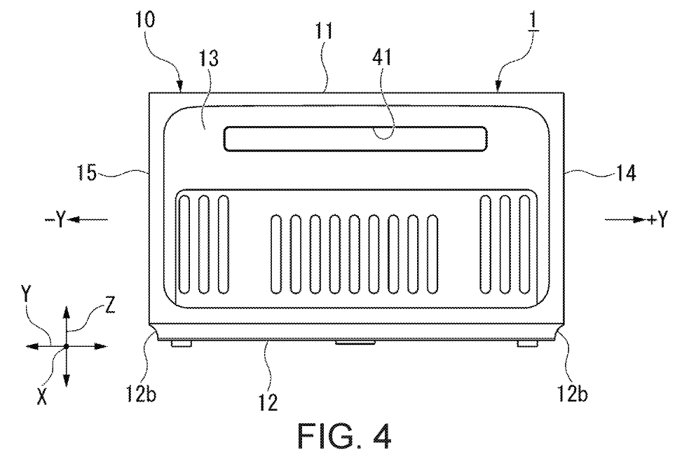

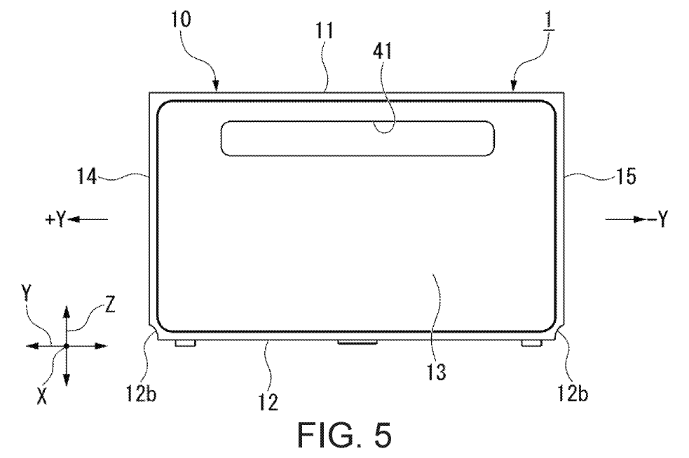

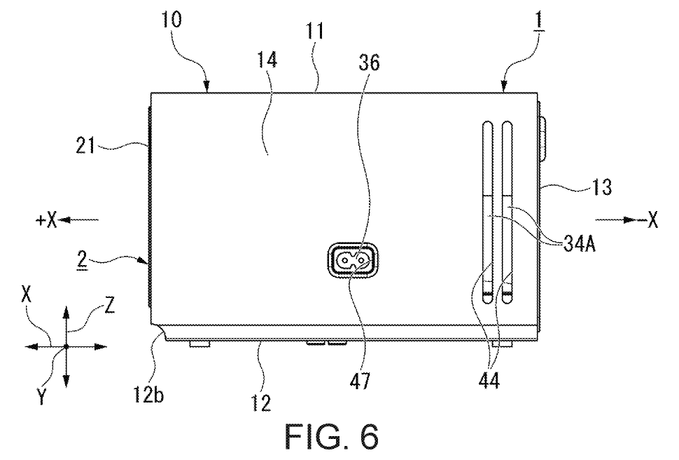

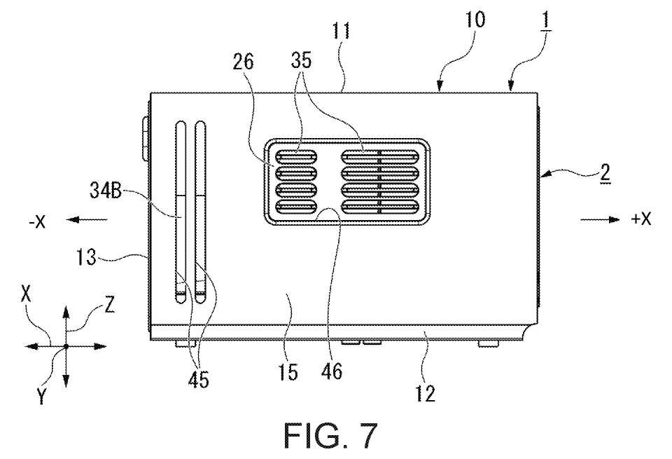

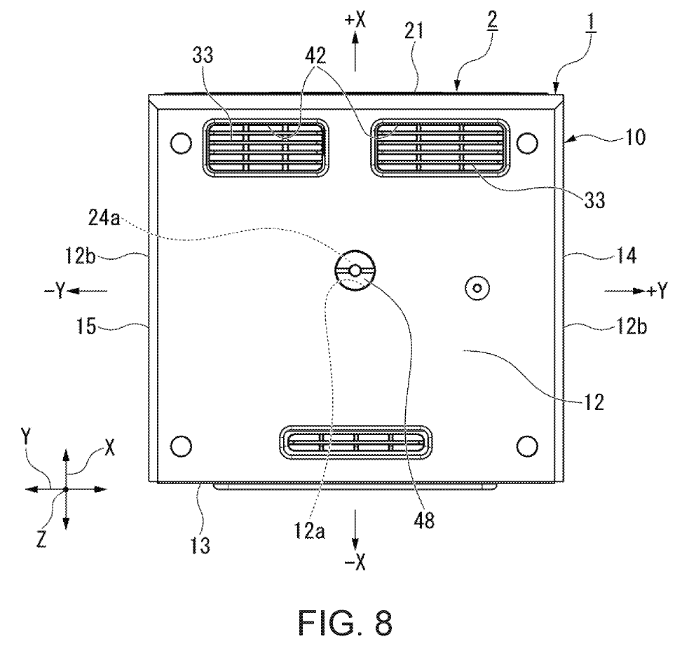

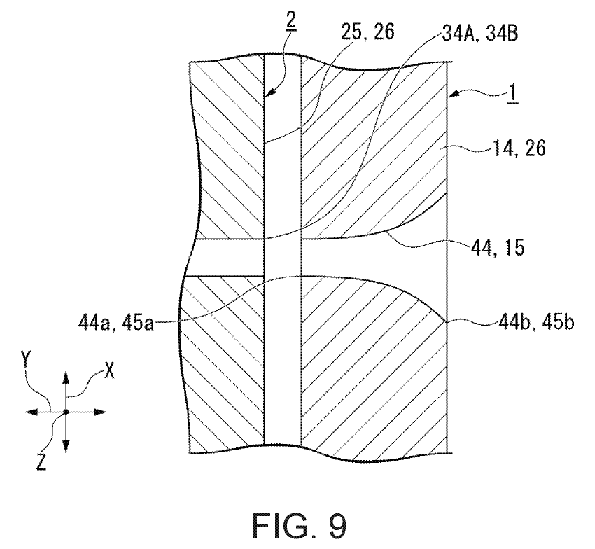

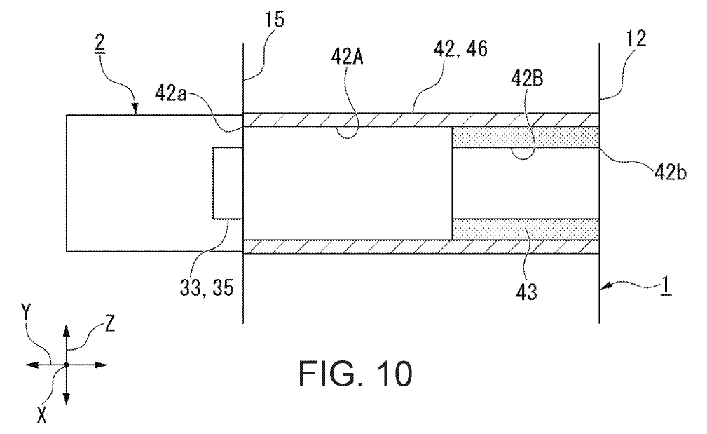

FIG. 3 is a perspective view illustrating a configuration of the projector 2 as viewed obliquely from the front. FIG. 4 is a front view of the cover member 1 as viewed from the front. FIG. 5 is a rear view of the cover member 1 as viewed from the rear. FIG. 6 is a side view of the cover member 1 that accommodates the projector 2, as viewed from a right side. FIG. 7 is a side view of the cover member 1 that accommodates the projector 2, as viewed from a left side. FIG. 8 is a plan view of the cover member 1 that accommodates the projector 2, as viewed from below. FIG. 9 is a horizontal cross-sectional view of speaker hole sections 44 and 45 as viewed from the vertical direction Z. FIG. 10 is a cross-sectional view of an intake port hole section 42 and an exhaust port hole section 46 as viewed from the front-rear direction X.

As illustrated in FIGS. 2 and 3, the outer housing 20 constitutes a housing of the projector 2. The outer housing 20 has a substantially rectangular parallelepiped box shape formed by a plurality of wall surfaces. The outer housing 20 includes a front surface 21, a rear surface 22, an upper surface 23, a lower surface 24, a right side surface 25, and a left side surface 26.

The front surface 21 is a wall surface facing rearward (+X direction) in the front-rear direction X intersecting the vertical direction Z, and the rear surface 22 is a wall surface facing forward (-X direction) in the front-rear direction X. The upper surface 23 is a wall surface facing the +Z direction in the vertical direction Z, and the lower surface 24 is a wall surface facing downward (-Z direction) in the vertical direction Z. The right side surface 25 is a wall surface facing forward (+Y direction) in the left-right direction Y intersecting the vertical direction Z, and the left side surface 26 is a wall surface facing rearward (-Y direction) in the left-right direction Y.

The front surface 21 is provided with a projection port 31 through which light passes. The projection port 31 is arranged on an upper side +Z in the vertical direction Z in the front surface 21.

The power supply section 32 is provided on the rear surface 22. The power supply section 32 includes a first connector section 32A for connecting an external power supply, and a power switch section 32B for turning the power of the projector 2 on and off. The power supply section 32 is arranged on an upper side (+Z direction) in the vertical direction Z in the rear surface 22. The first connector section 32A and the power switch section 32B are exposed to a rear side (-X direction) in the outer housing 20. The power supply section 32 supplies the power supplied from the external power supply connected to the projector 2 to sections of the projector 2.

The outer shape of each of the upper surface 23 and the lower surface 24 is substantially square in plan view. As illustrated in FIG. 8, the lower surface 24 is provided with an intake port 33 (intake and exhaust port) through which air outside the outer housing 20 is introduced into the interior of the outer housing 20.

The intake port 33 is arranged on a front side (+X direction) in the front-rear direction X in the lower surface 24. The intake port 33 is formed by a plurality of hole sections 33a penetrating the lower surface 24 in the vertical direction Z. The hole section 33a is, for example, a rectangular hole that is long in the left-right direction Y. In the present embodiment, two rows of the hole sections 33a are arranged in the left-right direction Y, each row including a large number of the hole sections 33a arranged in the front-rear direction X. Air introduced into the outer housing 20 through the intake port 33 is sucked into the outer housing 20 by a fan (not illustrated).

As illustrated in FIG. 2, the lower surface 24 is provided with a plurality of leg sections 24b. The plurality of leg sections 24b protrude downward (in the -Z direction) from four corner sections of the lower surface 24. A lower end section of each leg section 24b is in contact with the installation surface G. In a state in which the projector 2 is accommodated in the cover member 1, the lower end section of each leg section 24b is in contact with a lower cover 12 of the cover member 1.

The outer shape of the right side surface 25 is a substantially rectangular shape that is long in the front-rear direction X when viewed from a right side (+Y direction). The right side surface 25 is provided with a right speaker hole 34A through which a sound generated from a speaker (not illustrated) provided in the projector 2 is output. The right speaker hole 34A is arranged on a rear side (-X direction) in the right side surface 25. The right speaker hole 34A has a vertically elongated shape extending in the vertical direction Z.

A second connector section 36 for connecting an external device such as a computer that outputs an image signal is provided on the right side surface 25. The second connector section 36 is exposed on a right side (+Y direction) in a cover main body 10.

As illustrated in FIG. 3, the outer shape of the left side surface 26 is a substantially rectangular shape that is long in the front-rear direction X when viewed from a right side (+Y direction). The left side surface 26 is provided with a left speaker hole 34B through which a sound generated from a speaker (not illustrated) provided in the projector 2 is output. The left speaker hole 34B is provided at a position on an opposite side of the right speaker hole 34A in the left-right direction Y, and is arranged on a rear side (-X direction) in the left side surface 26. The left speaker hole 34B has a vertically elongated slit shape extending in the vertical direction Z.

The left side surface 26 is provided with an exhaust port 35 (intake and exhaust port) that discharges air inside the outer housing 20 including air introduced into the outer housing 20 from the intake port 33 to the outside of the outer housing 20.

The exhaust port 35 is arranged in a substantially central section of the left side surface 26 in the front-rear direction X and the vertical direction Z. The exhaust port 35 is constituted by a plurality of hole sections 35a penetrating the left side surface 26 in a thickness direction (left-right direction Y). The hole section 35a is, for example, a rectangular hole that is long in the front-rear direction X. In the present embodiment, two rows of the hole sections 35a are arranged in the front-rear direction X, each row including a large number of the hole sections 35a arranged in the vertical direction Z.

As illustrated in FIGS. 1, 2 and 4 to 8, the cover member 1 covers five surfaces of the projector 2 except for the front surface 21. The cover member 1 includes an upper cover 11 (second wall section), the lower cover 12 (first wall section), a rear cover 13, a right cover 14, and a left cover 15.

The upper cover 11 is a wall section that faces the upper surface 23 of the projector 2 from above (+Z direction), and the lower cover 12 is a wall section that faces the lower surface 24 of the projector 2 from below (-Z direction). The upper cover 11, the lower cover 12, and both side covers 14 and 15 constitute the cover main body 10 integrally formed in a tubular shape having a rectangular cross section.

The rear cover 13 is a wall section that faces the rear surface 22 of the projector 2 from the rear (-X direction). The rear cover 13 is detachably provided so as to close an opening on a rear side (-X direction) of the cover main body 10. That is, the rear cover 13 functions as a lid.

The right cover 14 is a wall section that faces the right side surface 25 of the projector 2 from a right side (+Y direction), and the left cover 15 is a wall section that faces the left side surface 26 of the projector 2 from a left side (-Y direction).

Wood is used as a material of the cover member 1. Examples of the wood include hinoki cypress, hiba arborvitae, paulownia, teak, mahogany, cryptomeria, zelkova, pine, cherry, and the like. Wood also includes synthetic wood. A surface (outer surface) of the cover member 1 made of wood may be subjected to surface treatment such as attaching or printing of a wood-grain sheet. In a cover member, a material other than wood may be used for a part having a small surface area of the appearance.

The covers of the cover member 1 are arranged so that grains on their surfaces (outer surfaces) are approximately parallel and face in the same direction. For example, it is desirable that a direction of the grain is the front-rear direction X. In particular, grain directions of the upper cover 11, the right cover 14, and the left cover 15 are desirably aligned in the same direction. When the direction of the grain is the front-rear direction X, it becomes approximately parallel to a boundary side of the cover main body 10, resulting in a good appearance. Alternatively, it is desirable that the grain is provided in a direction orthogonal to the front-rear direction X, that is, the grain of the upper cover 11, the lower cover 12, and the rear cover 13 is provided along the left-right direction Y, and the grain of the right cover 14 and the left cover 15 is provided along the vertical direction Z. This improves the appearance of the cover member 1, and the aesthetic appearance and the design can be enhanced.

As illustrated in FIGS. 4 and 5, the rear cover 13 includes a power supply hole section 41 (first hole section) that overlaps with the power supply section 32 provided on the rear surface 22 of the projector 2 in a plan view viewed from the rear in the front-rear direction X (-X direction). The power supply hole section 41 includes an opening larger than a peripheral edge of the power supply section 32. The power supply hole section 41 is arranged on an upper side (+Z direction) in the vertical direction Z in the rear cover 13. The power supply hole section 41 forms an elongated hole extending in the left-right direction Y. At least the first connector section 32A and the power switch section 32B of the power supply section 32 are exposed to a rear side (-X direction) through the power supply hole section 41. A user of the projector 2 can access the first connector section 32A and the power switch section 32B through the power supply hole section 41 of the cover member 1 to perform an on/off operation of the power supply and the like.

The lower cover 12 is arranged so as to cover an installation surface of the lower surface 24 of the projector 2. As illustrated in FIG. 8, a cutout section 12b is formed in an outer peripheral edge of the lower cover 12 so as to reduce a surface area of the lower surface. That is, a surface area of the lower cover 12 is set to be smaller than a surface area of the upper cover 11.

The lower cover 12 includes intake port hole sections 42 (third hole sections) that is arranged on a front side (+X direction) in plan view viewed from a lower side (-Z direction) and that faces the intake port 33 provided in the lower surface 24 of the projector 2. The intake port hole sections 42 are arranged in a pair at an interval in the left-right direction Y. Each of the intake port hole section 42 is, for example, a rectangular hole that is long in the left-right direction Y. Air introduced into the outer housing 20 from the intake port 33 reaches the intake port 33 through the intake port hole sections 42 of the cover member 1.

As illustrated in FIG. 10, the intake port hole section 42 constitutes a silencer having the Helmholtz's principle, and includes a first air chamber 42A provided on an inner opening 42a side facing the intake port 33, and a first throat section 42B provided on an outer opening 42b side with respect to the first air chamber 42A and having a smaller cross-sectional area than the first air chamber 42A. The first air chamber 42A extends along a hole axis direction (vertical direction Z) of the intake port hole section 42, and has the same cross section along the hole axis direction. A cross-sectional area of the first air chamber 42A is larger than a cross-sectional area of the intake port 33. That is, a cross-sectional area of the inner opening 42a of the intake port hole section 42 is larger than a cross-sectional area of the intake port 33. The first throat section 42B extends along a hole axis direction (vertical direction Z) of the intake port hole section 42, and has the same cross section along the hole axis direction. A cross-sectional area of the first throat section 42B is smaller than a cross-sectional area of the first air chamber 42A and is equal to the cross-sectional area of the intake port 33. That is, a cross-sectional area of an outer opening 42b of the intake port hole section 42 is smaller than the cross-sectional area of the first air chamber 42A and is equal to the cross-sectional area of the intake port 33.

A sound absorbing material 43 is provided on an inner surface of the first throat section 42B by, for example, adhering. Examples of materials of the sound absorbing material 43 include polystyrene foam, sponge, and wood.

As illustrated in FIG. 8, a first female screw section 24a (main body engagement section) is provided in the center in plan view on the lower surface 24 of the projector 2. The lower cover 12 is provided with a second female screw section 12a (first engagement section) at a position facing the first female screw section 24a in the center in plan view. The lower cover 12 is provided with a fixing screw 48 (coupling member) including a male screw formed thereon, which is screwed into the first female screw section 24a and the second female screw section 12a to fix the projector 2 and the cover member 1 to each other.

The fixing screw 48 is not limited to being provided on the lower cover 12. For example, a first screw hole (corresponding to the main body engagement section) for a ceiling mount bracket provided on the upper surface 23 of the projector 2 may be provided, a second screw hole (corresponding to the first engagement section) corresponding to the first screw hole may be provided in the upper cover 11, and a fixing screw screwed into the first screw hole and the second screw hole may be provided in the upper cover 11.

As illustrated in FIGS. 2 and 6, the right cover 14 includes right speaker hole sections 44 (second hole sections) at a position facing the right speaker hole 34A of the projector 2. The right speaker hole sections 44 are arranged on a rear side (-X direction) in the right cover 14, and overlap with the right speaker hole 34A when viewed from a right side (+Y direction). The right speaker hole section 44 has a vertically elongated slit shape extending in the vertical direction Z.

An outer opening 44b of the right speaker hole section 44 has a larger cross-sectional area than an inner opening 44a. As illustrated in FIG. 9, a cross-sectional area of the right speaker hole section 44 gradually increases as the distance from the right speaker hole 34A increases. The shape of the right speaker hole section 44 in side view is the same as a horn shape extending along a hyperbolic curve. The hyperbolic curve at this time is determined by, for example, a linear expression indicating Helmholtz resonance that is generally known. The change in the cross-sectional area of the right speaker hole section 44 is not limited to the smooth and continuous change as described above, and may be, for example, a shape in which the cross-sectional area changes stepwise along the above-described hyperbolic curve. The right speaker hole section 44 is not limited to a hole extending linearly in a thickness direction of the right cover 14 (direction orthogonal to the plane of the right cover 14), and a hole axis may be curved.

As illustrated in FIGS. 2 and 6, the right cover 14 includes a connector hole section 47 that is arranged substantially in the center in plan view viewed from a right side (+Y direction) and that faces the second connector section 36 provided on the right side surface 25 of the projector 2. The second connector section 36 is exposed to the right side (+Y direction) through the connector hole section 47. A user of the projector 2 can access the second connector section 36 through the connector hole section 47 of the cover member 1 to connect a connector.

As illustrated in FIG. 7, the left cover 15 includes left speaker hole sections 45 (second hole sections) at a position facing the left speaker hole 34B of the projector 2. The left speaker hole sections 45 are arranged on a rear side (-X direction) in the left cover 15, and overlap with the left speaker hole 34B when viewed from a left side (-Y direction). The left speaker hole section 45 has a vertically elongated slit shape extending in the vertical direction Z.

An outer opening 45b of the left speaker hole section 45 has a larger cross-sectional area than an inner opening 45a. As illustrated in FIG. 9, the cross-sectional area of the left speaker hole section 45 gradually increases as the distance from the left speaker hole 34B increases. The shape of the left speaker hole section 45 in side view is the same as a horn shape extending along a hyperbolic curve. The hyperbolic curve at this time is determined by, for example, a linear expression indicating Helmholtz resonance that is generally known. The change in the cross-sectional area of the left speaker hole section 45 is not limited to the smooth and continuous change as described above, and may be, for example, a shape in which the cross-sectional area changes stepwise along the above-described hyperbolic curve. The left speaker hole section 45 is not limited to a hole extending linearly in a thickness direction of the left cover 15 (direction orthogonal to the plane of the left cover 15), and a hole axis may be curved.

As illustrated in FIG. 7, the left cover 15 includes an exhaust port hole section 46 (third hole section) arranged on a front side (+X direction) in plan view viewed from a left side (-Y direction) and facing the exhaust port 35 provided in the left side surface 26 of the projector 2. The exhaust port hole section 46 is, for example, a rectangular opening hole that is long in the left-right direction Y. Air exhausted from the inside of the outer housing 20 through the exhaust port 35 is further exhausted to the outside through the exhaust port hole section 46 of the cover member 1.

As illustrated in FIG. 10, the exhaust port hole section 46 constitutes a silencer having the Helmholtz's principle, and includes a second air chamber 46A provided on an inner opening 46a side facing the exhaust port 35, and a second throat section 46B provided on an outer opening 46b side with respect to the second air chamber 46A and having a smaller cross-sectional area than the second air chamber 46A. The second air chamber 46A extends along a hole axis direction (left-right direction Y) of the exhaust port hole section 46, and has the same cross section along the hole axis direction. A cross-sectional area of the second air chamber 46A is larger than a cross-sectional area of the exhaust port 35. That is, a cross-sectional area of the inner opening 46a of the exhaust port hole section 46 is larger than a cross-sectional area of the exhaust port 35. The second throat section 46B extends along a hole axis direction (left-right direction Y) of the exhaust port hole section 46, and has the same cross section along the hole axis direction. A cross-sectional area of the second throat section 46B is smaller than a cross-sectional area of the second air chamber 46A and is equal to the cross-sectional area of the exhaust port 35. That is, a cross-sectional area of an outer opening 46b of the exhaust port hole section 46 is smaller than the cross-sectional area of the second air chamber 46A and is equal to the cross-sectional area of the exhaust port 35.

The sound absorbing material 43 similar to the sound absorbing material 43 provided on an inner surface of the intake port hole section 42 described above is provided on an inner surface of the second throat section 46B by, for example, adhering. Examples of materials of the sound absorbing material 43 include polystyrene foam, sponge, and wood.

Next, an operation of the projector cover member (cover member 1) will be described.

As illustrated in FIG. 1, the cover member 1 according to the present embodiment is a projector cover member that covers a projector including the outer housing 20, the power supply section 32 arranged in the outer housing 20, and an image light generation module controlled by the power supply section 32. At least an outer surface is formed of wood, and the power supply hole section 41 is provided to overlap with the power supply section 32 in plan view. The power supply hole section 41 includes an opening larger than a peripheral edge of the power supply section 32.

Therefore, in the present embodiment, even when wood is provided in at least a part of the cover member 1 that covers the projector 2, the power supply section 32 of the projector 2 can be easily operated through the power supply hole section 41. In the present embodiment, since the projector 2 is covered with the cover member 1 including at least a part of the outer surface formed of wood, the entire appearance is woody, and the design of the projector 2 can be enhanced. As described above, in the present embodiment, the projector 2 is user-friendly without losing the function thereof, and the projector 2 is covered with the cover member 1 made of wood, whereby the appearance of the projector 2 can be improved.

The cover member 1 according to the present embodiment includes the speaker hole sections 44 and 45 at positions facing the speaker holes 34A and 34B provided in the projector 2. According to this configuration, a sound emitted from the speaker holes 34A and 34B can be made to flow to the outside of the cover member 1 through the speaker hole sections 44 and 45. Therefore, even when the projector 2 is covered with the cover member 1 formed of wood, it is possible to prevent a sound emitted from the speaker holes 34A and 34B from being blocked from the outside and becoming difficult to hear.

According to the cover member 1 according to the present embodiment, cross-sectional areas of the speaker hole sections band 45 of the cover member 1 are configured such that cross-sectional areas on inner openings 44a and 45a side in a wall thickness direction is smaller than cross-sectional areas on outer openings 44b and 45b side. According to this configuration, the frequency characteristics of a sound emitted from the speaker holes 34A and 34B can be changed by the speaker hole sections 44 and 45 to increase the volume, and the acoustic performance of the projector 2 can be improved.

The cover member 1 according to the present embodiment includes the intake port hole section 42 and the exhaust port hole section 46 at positions facing the intake and exhaust port (the intake port 33 and the exhaust port 35) of the projector 2, respectively. According to this configuration, even when the projector 2 is covered with the cover member 1 formed of wood, air outside the cover member 1 can be efficiently introduced into the intake port 33 through the intake port hole section 42, and air inside the projector 2 can be efficiently exhausted to the outside of the cover member 1 from the exhaust port 35 through the exhaust port hole section 46. The cover member 1 may include only one of the intake port hole section 42 and the exhaust port hole section 46.

According to the projector cover member 1 according to the present embodiment, the intake port hole section 42 and the exhaust port hole section 46 have the air chambers 42A and 46A provided on inner openings 42a and the 46a sides facing the intake port 33 and the exhaust port 35 corresponding thereto, respectively, and the throat sections 42B and 46B provided on outer openings 42b and 46b sides with respect to the air chambers 42A and 46A, respectively, and having smaller cross-sectional areas than the air chambers 42A and 46A, respectively. According to this configuration, the cover member 1 that covers the projector 2 is provided with the intake port hole section 42 and the exhaust port hole section 46 including the Helmholtz structure including the air chambers 42A and 46A and the throat sections 42B and 46B, resulting in a configuration that improves space efficiency. Therefore, a sound pressure of the specific frequency is lowered, and the sound absorption effect can be exhibited, and noise of the projector 2 can be reduced.

According to the cover member 1 according to the present embodiment, cross-sectional areas of the throat sections 42B and 46B are equal to cross-sectional areas of the intake port 33 and the exhaust port 35, respectively. In this case, air flowing through the throat sections 42B and 46B is not disturbed, and air can flow substantially linearly. Therefore, it is possible to suppress turbulent flow of air flowing through the inside of the intake port hole section 42 and the exhaust port hole section 46, and it is possible to suppress generation of noise due to the turbulent flow and achieve silencing.

According to the cover member 1 according to the present embodiment, the sound absorbing material 43 is provided on an inner surface of each of the throat sections 42B and 46B. According to this configuration, a sound pressure of air passing through the sound absorbing material 43 of the throat sections 42B and 46B can be further reduced, and the sound absorption effect can be enhanced.

The cover member 1 according to the present embodiment includes the lower cover 12 that covers an installation surface of the projector 2 and the upper cover 11 opposite to the lower cover 12. A surface area of the lower cover 12 is smaller than a surface area of the upper cover 11. According to this configuration, for example, by providing a cutout section formed by cutting out an outer peripheral edge of the lower cover 12, the visibility on an installation surface side can be reduced, and the appearance can be improved. That is, even when an installation section such as a leg is arranged on an installation surface of the projector 2 and a dead space is generated, it is possible to improve the appearance of the cover member 1. By providing the cutout section in an outer edge section of the lower cover 12, it is possible to easily hold the cover member 1 accommodating the projector 2, and it is possible to improve the functionality as the projector 2 by making it easy to perform adjustment by an angle adjustment mechanism, for example.

According to the cover member 1 according to the present embodiment, the first female screw section 24a is provided in the projector 2. The cover member 1 further includes the second female screw section 12a arranged at a position facing the first female screw section 24a, and the fixing screw 48 that engages with the second female screw section 12a and the first female screw section 24a to fix the projector 2. According to this configuration, the cover member 1 and the projector 2 accommodated in the cover member 1 can be fixed to each other using the fixing screw 48. This allows the cover member 1 to be attached to the projector 2 at a predetermined position without being misaligned, and the power supply section 32 of the projector 2 can be reliably exposed at least through the power supply hole section 41.

The cover member 1 according to the present embodiment includes a plurality of side wall sections including wood arranged on an outer surface thereof. Grain directions of the plurality of side wall sections are aligned with each other. In this case, since the cover member 1 is formed of wood, a grain direction of the outer surface can be set in the same direction to provide a good appearance. Even if wood warps, for example, misalignment of a grain portion becomes less noticeable, and the uncomfortable feeling in appearance can be suppressed. That is, the difference in a warping direction of the respective side wall sections over time is easily maintained in a small state, and the durability is improved.

According to the cover member 1 according to the present embodiment, since the wood is hinoki cypress, the workability is good, and since the cover member 1 also has an antibacterial property, deterioration over time can be suppressed.

While certain embodiments have been described, these embodiments have been presented by way of example only, and are not intended to limit the scope of the disclosure. These embodiments can be implemented in various other forms, and various omissions, substitutions, and modifications can be made without departing from the spirit of the disclosure. These embodiments and modifications thereof are included in the scope and gist of the disclosure, and are also included in the disclosure described in the claims and the scope of equivalents thereof.

In the embodiment described above, the cover member 1 is provided so as to cover the five surfaces of the projector 2 except the front surface 21, but the cover member may cover the entire surfaces of the projector 2.

A summary of the present disclosure is provided below.

### First note

A projector cover member configured to cover a projector, the projector including an outer housing, a power supply section arranged in the outer housing, and an image light generation module controlled by the power supply section, wherein

at least an outer surface of the projector cover member is formed of wood,

the projector cover member includes a first hole section that overlaps with the power supply section in plan view, and

the first hole section includes an opening larger than a peripheral edge of the power supply section.

According to the projector cover member including the configuration of first note, even when wood is provided in at least a part of the projector cover member that covers the projector, the power supply section of the projector can be easily operated through the first hole section. In the configuration of first note, since the projector is covered with the projector cover member including the outer surface at least partially formed of wood, the entire appearance is woody, and the design of the projector can be enhanced. As described above, in first note, the projector is user-friendly without losing the function thereof, and the projector is covered with the projector cover member made of wood, whereby the appearance of the projector can be improved.

### Second note

The projector cover member according to first note, wherein

the projector cover member includes a second hole section at a position facing a speaker hole provided in the projector.

According to the configuration of second note, a sound emitted from the speaker hole can be made to flow to the outside of the projector cover member through the second hole section. Therefore, even when the projector is covered with the projector cover member formed of wood, it is possible to prevent a sound emitted from the speaker hole from being blocked from the outside and becoming difficult to hear.

### Third note

The projector cover member according to second note, wherein

a cross-sectional area of the second hole section on an inner opening side in a wall thickness direction is smaller than a cross-sectional area on an outer opening side.

According to the configuration of third note, the frequency characteristics of a sound emitted from the speaker hole can be changed by the second hole section to increase the volume,

and the acoustic performance of the projector can be improved.

### Fourth note

The projector cover member according to first note or second note, wherein

the projector cover member includes a third hole section at a position facing an intake and exhaust port of the projector.

According to the configuration of fourth note, even when the projector is covered with the projector cover member formed of wood, air outside the projector cover member can be efficiently introduced into, for example, the intake port through the third hole section, and air inside the projector can be efficiently exhausted to the outside of the projector cover member from, for example, the exhaust port through the third hole section.

### Fifth note

The projector cover member according to fourth note, wherein

the third hole section includes

an air chamber provided on an inner opening side facing the intake and exhaust port and

a throat section provided on an outer opening side of the air chamber and having a cross-sectional area smaller than that of the air chamber.

According to the configuration of fifth note, since the projector cover member that covers the projector is provided with the third hole section having the Helmholtz structure including the air chamber and the throat section, the configuration is such that space efficiency is improved. Therefore, a sound pressure of the specific frequency is lowered, and the sound absorption effect can be exhibited, and noise of the projector can be reduced.

### Sixth note

The projector cover member according to fifth note, wherein

the throat section has a cross-sectional area equal to a cross-sectional area of the intake and exhaust port.

According to the configuration of sixth note, air flowing through the throat section is not disturbed, and air can flow substantially linearly. Therefore, it is possible to suppress turbulent flow of air flowing through the inside of the third hole section, and it is possible to suppress generation of noise due to the turbulent flow and achieve silencing.

### Seventh note

The projector cover member according to fifth note, wherein

a sound absorbing material is provided on an inner surface of the throat section.

According to the configuration of seventh note, a sound pressure of air passing through the sound absorbing material of the throat section can be further reduced, and the sound absorption effect can be enhanced.

### Eighth note

The projector cover member according to first note further includes

a first wall section that covers an installation surface of the projector and a second wall section opposite the first wall section, wherein

a surface area of the first wall section is smaller than a surface area of the second wall section.

According to the configuration of eighth note, for example, by providing a cutout section formed by cutting out an outer peripheral edge of the first wall section, the visibility on an installation surface side can be reduced, and the appearance can be improved. That is, even when an installation section such as a leg is arranged on an installation surface of the projector and a dead space is generated, it is possible to improve the appearance of the projector cover member. By providing the cutout section in an outer edge section of the first wall section, it is possible to easily hold the projector cover member accommodating the projector, and it is possible to improve the functionality as the projector by making it easy to perform adjustment by an angle adjustment mechanism, for example.

### Ninth note

The projector cover member according to first note, wherein

the projector is provided with a main body engagement section and

the projector cover member further includes

a first engagement section arranged at a position facing the main body engagement section and

a coupling member that engages with the first engagement section and the main body engagement section to fix the projector and the cover member.

According to the configuration of ninth note, the projector cover member and the projector accommodated in the projector cover member can be fixed to each other using the coupling member. This allows the projector cover member to be attached to the projector at a predetermined position without being misaligned, and the power supply section of the projector can be reliably exposed at least through the first hole section.

### Tenth note

The projector cover member according to first note further includes

a plurality of side wall sections having the wood arranged on their outer surfaces, wherein

grain directions of the plurality of side wall sections are aligned with each other.

According to the configuration of tenth note, since the projector cover member is formed of wood, a grain direction of the outer surface can be set in the same direction to provide a good appearance. Even if wood warps, for example, misalignment of a grain portion becomes less noticeable, and the uncomfortable feeling in appearance can be suppressed. That is, the difference in a warping direction of the respective side wall sections over time is easily maintained in a small state, and the durability is improved.

### Eleventh note

The projector cover member according to first note, wherein

the wood is hinoki cypress.

According to the configuration of eleventh note, the workability is good and the antibacterial property is also provided, so that deterioration over time can be suppressed.

What is claimed is:

1. A projector cover member configured to cover a projector, the projector including an outer housing, a power supply section arranged in the outer housing, and an image light generation module controlled by the power supply section, wherein
at least an outer surface of the projector cover member is formed of wood,
the projector cover member includes a first hole section that overlaps with the power supply section in plan view, and
the first hole section includes an opening larger than a peripheral edge of the power supply section.

2. The projector cover member according to claim 1, wherein
the projector cover member includes a second hole section at a position facing a speaker hole provided in the projector.

3. The projector cover member according to claim 2, wherein
a cross-sectional area of the second hole section on an inner opening side in a wall thickness direction is smaller than a cross-sectional area on an outer opening side.

4. The projector cover member according to claim 1, wherein
the projector cover member includes a third hole section at a position facing an intake and exhaust port of the projector.

5. The projector cover member according to claim 4, wherein
the third hole section includes
an air chamber provided on an inner opening side facing the intake and exhaust port and
a throat section provided on an outer opening side of the air chamber and having a cross-sectional area smaller than that of the air chamber.

6. The projector cover member according to claim 5, wherein
the throat section has a cross-sectional area equal to a cross-sectional area of the intake and exhaust port.

7. The projector cover member according to claim 5, wherein
a sound absorbing material is provided on an inner surface of the throat section.

8. The projector cover member according to claim 1, further including
a first wall section that covers an installation surface of the projector and a second wall section opposite the first wall section, wherein
a surface area of the first wall section is smaller than a surface area of the second wall section.

9. The projector cover member according to claim 1, wherein
the projector is provided with a main body engagement section and
the projector cover member further includes
a first engagement section arranged at a position facing the main body engagement section and
a coupling member that engages with the first engagement section and the main body engagement section to fix the projector.

10. The projector cover member according to claim 1, further including
a plurality of side wall sections having the wood arranged on their outer surfaces, wherein
grain directions of the plurality of side wall sections are aligned with each other.

11. The projector cover member according to claim 1, wherein
the wood is hinoki cypress.
